(19) United States
(12) Patent Application Publication
(10) Pub. No.: US 2020/0085016 A1
(43) Pub. Date: Mar. 19, 2020

(54) Pet Toy

(71) Applicants: Eric William Millward, Evanston, IL (US); Kyle Marshall Welker, Denver, CO (US)

(72) Inventors: Eric William Millward, Evanston, IL (US); Kyle Marshall Welker, Denver, CO (US)

(21) Appl. No.: 16/132,455

(22) Filed: Sep. 16, 2018

(51) Int. Cl. A01K 15/02

(52) U.S. Cl. CPC A01K 15/025; A63H 9/00

(57) ABSTRACT

The invention is a durable squeaking pet toy which has rope ends for a pet or owner to tug and causes an accordion housing within the toy to expand and force air through air inlets and outlets invisible within a plush covering, thus causing a squeaking sound. The toy will squeak both on air intake and air outlet. Colorful plush coverings can be in shapes of animals to further entice the pet.

### FIELD

The present invention relates generally to stimulating, encouraging and motivating games and methods of playing regarding pets, e.g. dogs and cats. More particularly, the invention relates to motivational games, toys and methods for assessing the pet training skills in the form of games or puzzles that incite pet interaction and memory skills.

### PRIOR ART

There are many types of pet toys on the market that squeak or that can be used in a tug-of-war game between an owner and a dog, or multiple dogs without their owner's interaction. This novel tug-to-squeak toy is designed for durability regardless of how large the pet may be.

### BRIEF DESCRIPTION OF THE INVENTION

The novel design of the inventive toy allows a pet to tug on one side of the toy and the pet owner or another pet to pull the opposite end. As the ends are pulled, an accordion chamber with internal noisemaker set between two straps connected to the rope handle or rope piece end is activated by the lateral forces and causes the accordion housing to expand outward and allow air through inlets in the accordion, causing the toy to squeak.

The object of the present invention is to motivate and maintain interest of a pet. Non-stretch webbing connects the rope handle and rope pieces on each end of the toy to loops on each end of the accordion squeaker. The non-stretch webbing insures that the internal accordion squeaker is expanded by tugging force, and compresses the squeaker causing sounds to be emitted on by tugging and the depression, as well as the accordion squeaker returns to rest.

The squeaker located inside the accordion shell is novel over similar “tug-to-squeak” toys as it does not require any fabric, elastic or webbing to surround the internal mechanism to make the toy emit sound. No complicated systems of rope or other internal characteristics makes the inventive toy less prone to failure. The inventive squeaker toy will last far longer than the toys in the art.

### BACKGROUND OF THE INVENTION

The invention most closely corresponds with USPTO Class 119/707 wherein Class 119 relates to animal husbandry and sub-class 707 includes toys, lures, fetch and related devices.

In its simplest form, the invention relates to a novel toy for pets with a rope handle at one end and a rope tail piece on the other, wherein an internal accordion squeaker is firmly fastened to each end of the toy by non-stretch webbing. When the ends are pulled, the toy emits sound.

### THE INVENTION

### Summary, Objects and Advantages

It well known that pets do experience a sense of boredom, and if not addressed, may manifest in negative behavior such as chewing furniture or going to the bathroom in undesirable locations in the pet owner's home. The inventive toy is designed to capture and retain a pet's interest whether the pet owner is away or home. The pet owner can manipulate the toy in some way to actively play with the pet as well. The toy is not designed to “replace” human interaction, but rather to help keep a pet entertained even if the owner is not also interacting with the toy and pet.

### BRIEF DESCRIPTION OF THE DRAWINGS

The invention is described in further detail by reference to nine (9) drawings sufficient in detail to describe the invention in which:

FIG. 1 is an illustration of primarily the accordion squeaker portion;

FIG. 2 is an enlarged view of the accordion squeaker from a side perspective;

FIG. 3 is a head-on view of the accordion squeaker;

FIG. 4 is another side perspective of the accordion squeaker;

FIG. 5 is a top down perspective of the accordion squeaker;

FIG. 6 is the actual squeaker as affixed inside the accordion portion;

FIG. 7 is an enlarged view of the attachment points on the accordion squeaker;

FIG. 8 is a cutaway view of the accordion squeaker portion, and

FIG. 9 is an example of a preferred embodiment for a plush toy outer.

### DETAILED DESCRIPTION, INCLUDING BEST MODES OF CARRYING OUT THE INVENTION

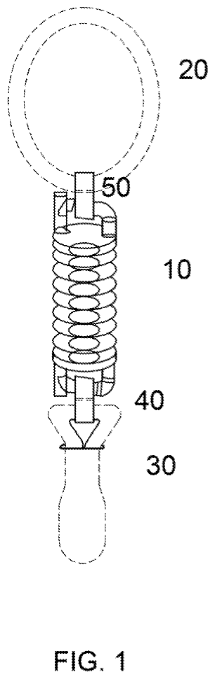

FIG. 1 shows the molded plastic accordion housing 10. In another Fig the squeaker itself is illustrated. One end of the accordion is a looped rope piece 20, and at the opposite end a rope “tail” 30. A pet and/or owner pulls on one of the ends to cause the accordion to stretch and allow airflow to the squeaker. At each end of the molded accordion there are loops 40 through which non-stretch webbing 50 affixes each rope section to the accordion.

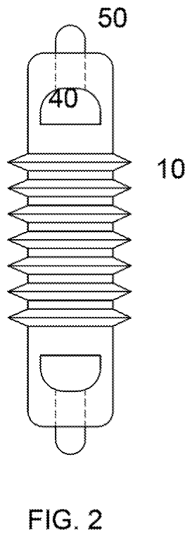

FIG. 2 is an enlarged view of the accordion 10, and each end loop 40 as the non-stretch webbing 50 is affixed to created tension points for a time when a pet or owner pulls on one end of the toy. This again stretches the accordion and airflow will results in an internal squeaker to emit sound.

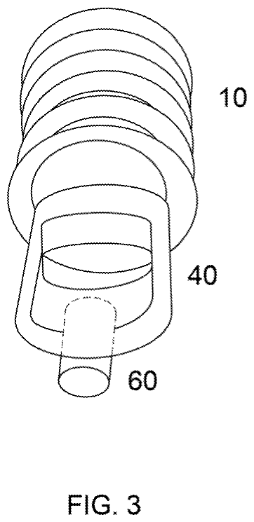

FIG. 3 is an angled head-on view of the accordion 10 and the loops 40 for receiving the non-stretch webbing. Each end of the accordion piece has a single air inlet 60 and a single air outlet. When the accordion is stretched, the air is allowed to move through one of the ports and aid in causing sound to emit from the toy.

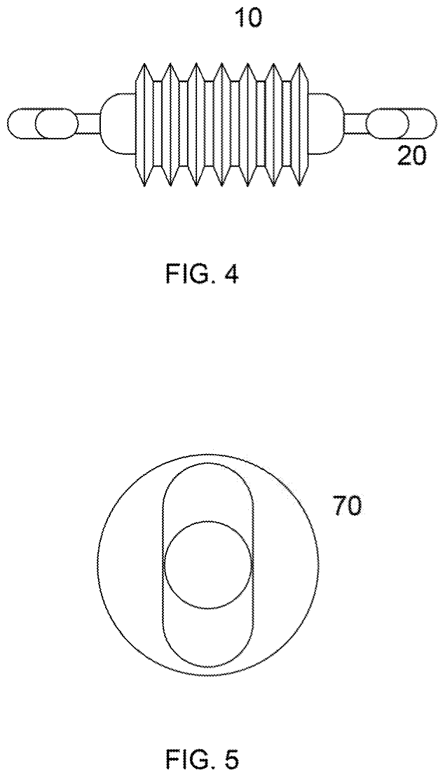

FIG. 4 is a simple perspective of the accordion piece 10 and the end loops 40 for receiving the non-stretch webbing.

FIG. 5 is a top-down view 70 of the accordion piece 10. This view is sans any air ports or loops for clarity.

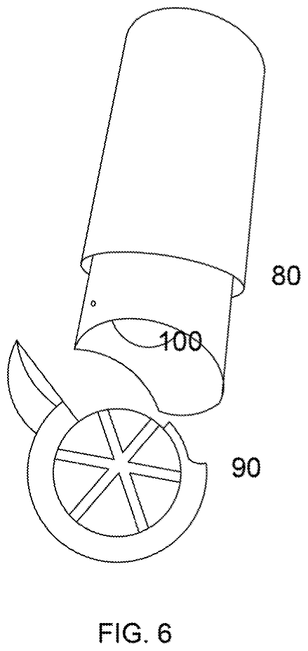

FIG. 6 is an exploded view of the squeaker 80 which resides in the accordion piece and responds to air movement when the toy is manipulated. The reed housing 80 is barrel shaped and contains an air inlet “wheel” 90 affixed to the reed housing. A reed 100 seated within the housing vibrates to create sound. This entire feature responds to air intake or exhale in response to the accordion end pieces being pulled upon.

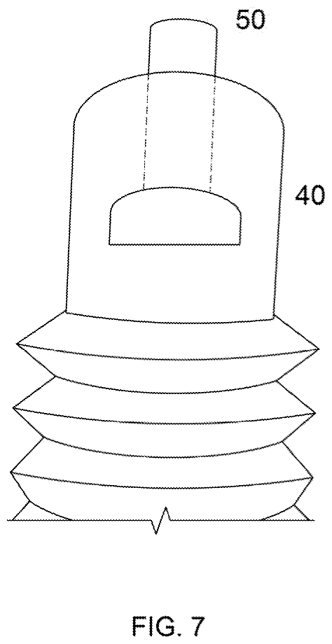

FIG. 7 is a magnified view of the accordion piece 10, the loops 40 through which the non-stretch material affixes 50. The design is simple, yet an improvement over other squeak toys which require some type of banding around a squeaker to cause it to emit sound. These methods are not durable.

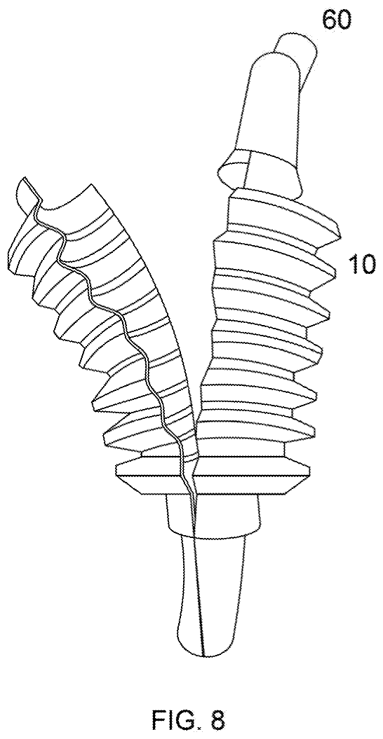

FIG. 8 is a cutaway image of the accordion 10 and an air intake/outlet port 60. Air traveling through a port reacts with the squeaker reed and causes to squeaker to emit sound. Sound may be heard after the ends of the toy are pulled to stretch the accordion, and also as the accordion returns to a “rest” state, i.e. undepressed.

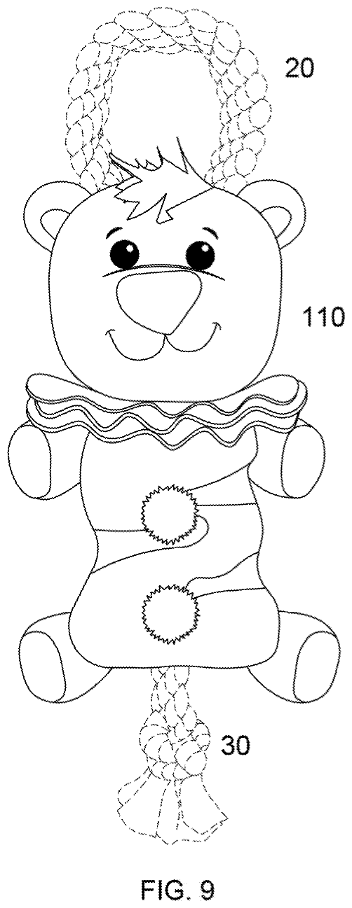

FIG. 9 is a preferred embodiment of a plush outer covering 110 through which the rope ends 20 and 30 protrude from each end (or top/bottom) of the toy. The ends are pulled as described supra and the according and reed squeaker respond accordingly. The plush feature is colorful and aids in stimulating the pet to play. As with this Figure, the tail end 30 of the rope may be knotted.

1) A pet toy comprising:
a) A single piece plastic molded accordion chamber having a loop at each end that connect to air intakes or outlets as well as two ends of rope;
b) A reed squeaker nested inside the accordion chamber;
c) Air intake and outlet holes molded and protruding from each end of the accordion chamber and connected to the end loops of the accordion;
d) Non-stretch webbing fabric which loops through each end of the accordion piece to affix to a circular roped end, and a tail roped end;
e) A plush fabric covering which has openings at the top and bottom for allowing the rope ends to extrude and be grasped by a pet or pet owner.

2) A pet toy as in claim 1 wherein the molded accordion piece will expand when rope ends are pulled by a user or pet and force air through the intake or outlet and react with a reed squeaker nested within the chamber.

3) A pet toy as in claim 1 wherein the looped ends of the accordion piece create loops for which to thread non-stretch webbing that connects a rope end to it and to the rope ends.

4) A pet toy as in claim 1 wherein the material affixing the rope to the accordion must be non-stretch fabric to insure the accordion chamber is able to extend easily when the rope ends are pulled.

6) A pet toy as in claim 1 wherein a plush fabric outer piece is crafted in the image of an animal, as in the bear embodiment herein, and where the top and bottom of the outer plus have opening through which the ropes ends extrude.

7) A pet toy as in claim 1 wherein the rope tail portion contains an elastic band that gathers the rope end which is protruding from the plush casing and wherein the band is then sewn together so the rope does not fray.
